(19) United States
(12) Patent Application Publication
(10) Pub. No.: US 2014/0108408 A1
(43) Pub. Date: Apr. 17, 2014

(54) TOPIC COLLECTIONS

(71) Applicant: MICROSOFT CORPORATION, Redmond, WA (US)

(72) Inventors: Timothy Edgar, Bellevue, WA (US); John Licata, Woodinville, WA (US); Chen Fang, Bellevue, WA (US)

(73) Assignee: Microsoft Corporation, Redmond, WA (US)

(21) Appl. No.: 13/649,552

(22) Filed: Oct. 11, 2012

(51) Int. Cl. G06F 17/30

(52) U.S. Cl. 707/738; 707/E17.046

(57) ABSTRACT

Among other things, one or more techniques and/or systems are provided for maintaining a topic collection. That is, a topic collection (e.g., a vacation topic collection) may be created for a user, such that the user may store content associated with various applications (e.g., images from a social network app, vacation blogs, hotel price lists, sightseeing websites, etc.) as one or more entries within the topic collection. In this way, the user may easily organize, review, and/or share content through the topic collection. Recommendations of supplement content, which may be relevant to the topic collection, may be provided to the user. For example, entries within vacation topic collections of other users (e.g., to similar destinations) may be identified as supplemental content and recommended to the user. In this way, the user may accomplish a search task by organizing content into a single source.

### BACKGROUND

Many users may discover and interact with content through applications, such as a web browser, a map application, a shopping application, etc. In one example, a user may utilize a web browser to search for websites, images, videos, and/or other content by submitting a search query to a search engine. The search engine may provide the user with search results, such as web pages, that are relevant to the search query. In this way, the user may perform various searches over time in order to accomplish a search task (e.g., plan a vacation, research a product purchase, answer medical questions, buy a gift, etc.). Because a single search result may not completely answer the search task, the search process may involve users keeping multiple web pages open, booking marking web pages, sending links or content to an email account for storage, and/or other manual techniques for gathering and organizing content over time. Unfortunately, manually organizing content may be a cumbersome task that may result in content being stored across various locations, such as email accounts, bookmark folders, web browser tabs, file folders, and/or multiple computing devices.

### SUMMARY

This summary is provided to introduce a selection of concepts in a simplified form that are further described below in the detailed description. This Summary is not intended to identify key factors or essential features of the claimed subject matter, nor is it intended to be used to limit the scope of the claimed subject matter.

Among other things, one or more systems and/or techniques for maintaining a topic collection are provided herein. That is, a user may create a topic collection within which the user may add one or more entries corresponding to content (e.g., a web page viewed through a web browser, a restaurant review provided by a restaurant app on a tablet device, a video game summary provided by a video game console, driving directions provided by a map application on a mobile device, etc. comprising images, URLs, social media profiles, videos, text blogs, live data, and/or any other types of content). In this way, the user may access, organize, and/or share such content through the topic collection (e.g., hotel web pages, beach images, tour guide videos, and/or other content corresponding to one or more entries within a vacation topic collection).

In one example of maintaining a topic collection, a topic generation request may be received. For example, a first user may issue a request to create a vacation topic collection that may be used to store content associated with planning a vacation. In this way, the vacation topic collection may be created for the first user based upon the topic generation request. The first user and/or other authorized users (e.g., a second user with whom the first user has shared the vacation topic collection) may be able to populate the vacation topic collection from various computing devices (e.g., a tablet computing device, a mobile phone, a desktop, a video game console, etc.) using various applications (e.g., a map application, a web browser, a restaurant application, an image web service, etc.). For example, a topic populate request corresponding to content associated with a first application (e.g., a vacation blog accessed through a web browser) may be received. A first entry may be added into the topic collection based upon the content. For example, a link to the vacation blog, a user selected image representative of the vacation blog, and/or a user comment describing the vacation blog may be added into the first entry. In this way, one or more entries may be added to the vacation topic collection (e.g., a hotel price list, beach images from a social network app, a hotel review web page, etc.).

The topic collection may be accessible from various platforms, such as computing devices (e.g., a mobile phone, a tablet device, a desktop device, and/or other devices), applications, etc. For example, content organized into the vacation topic collection may be accessible through a website, a web application, a mobile app, a tablet application, a rich client application, a web service, etc. In one example, content may be accessible through a topic collection application (e.g., a note written by the user or a song/photo sent to the topic collection application). In another example, content may be accessible by launching a new application from a topic collection application (e.g., mapping directions may be launched through a map application from the topic collection application). In another example, content may be accessible through a website, which may navigate the user to a sources of the content (e.g., a different website, a web application, an application, etc.).

A recommendation comprising supplemental content (e.g., not comprised within the topic collection) may be provided to the first user. In one example, information within the vacation topic collection (e.g., the hotel review web page) may be used to locate supplemental content. For example, features extracted from the hotel reservation web page may be used to search for supplemental content through a web search engine. In another example, an entry within a second vacation topic collection associated with a second user, but not within the vacation topic collection associated with the first user, may be identified as supplement content for the first user. In this way, a recommendation comprising supplement content may be provided to the first user, which may help the first user complete a search task (e.g., plan a vacation) that motivated the generation of the vacation topic collection.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of maintaining a topic collection.

FIG. 2 is a component block diagram illustrating an exemplary system for maintaining a topic collection.

FIG. 3 is a component block diagram illustrating an exemplary system for maintaining a topic collection.

FIG. 4 is a component block diagram illustrating an exemplary system for maintaining a topic collection.

FIG. 5 is an illustration of an example of a set of topic collections for a first user.

FIG. 6 is a component block diagram illustrating an exemplary system for providing a recommendation for a topic collection of a first user.

FIG. 7 is a component block diagram illustrating an exemplary system for sharing a topic collection from a first user to one or more other users.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

In order to complete a search task, such as researching a car purchase, a user may utilize various computing devices and/or applications over time for locating content that may be useful in making a decision for the search task. While researching for the car purchase, the user may bookmark various car review websites, generate an email comprising content from a car pricing application, copy and paste text of a car blog into a file for later review, and/or perform other various actions. Unfortunately, such dispersed and unorganized content may be of little help to the user until the user manually aggregates and/or organizes the content from various sources (e.g., email accounts, file folders, bookmarks, computing devices, etc.). Accordingly, as provided herein, a topic collection may be generated for the user, such that the user may populate the topic collection with one or more entries associated with such content. The topic collection may provide a single organized source for content. The topic collection may be accessed from various computing devices, organized, shared with other users, and/or used to provide recommendations to the user. It may be appreciated that in an example, the user may organize a wide variety of content into the topic collection, such as images, URLs, videos, social media user profiles, text blogs, an application, live data, and/or any other content. In an example, the content organized into the topic collection may comprise dynamic data. In an example of dynamic data, a map application tile may be added to a vacation planning topic collection, such that the user may access the map application tile through the vacation planning topic collection to obtain dynamic driving data (e.g., real-time information corresponding to travel time/distance remaining from a current location of the user to a destination location). In another example of dynamic data, a currency conversion web service may be added to the vacation planning topic collection, such that the user may access the currency conversion web service to obtain current market conversion rates. In this way, content organized into a topic collection may provide the user with dynamic (e.g., live, real-time, etc.) data.

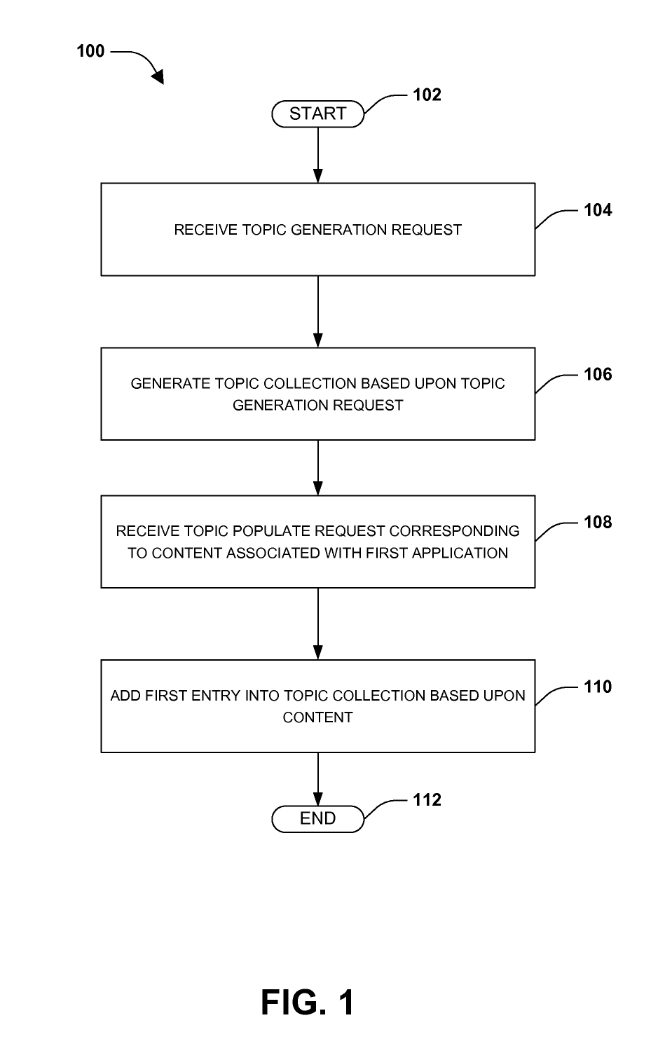

One embodiment of maintaining a topic collection is illustrated by exemplary method 100 in FIG. 1. At 102, the method starts. At 104, a topic generation request is received. For example, a first user may submit a request to generate a video game purchase topic collection within which the first user may add one or more entries associated with content (e.g., video game reviews, video game pricing, etc.) from various applications (e.g., a shopping application, a video game website, etc.). At 106, the topic collection is generated based upon the topic generation request. For example, the video game purchase topic collection may be generated for the first user, and may be assigned a topic of “video game purchase”.

The video game purchase topic collection may be populated with content by the first user and/or by other users with whom the first user has shared the video game purchase topic collection. In particular, a topic populate request corresponding to content associated with a first application may be received, at 108. It may be appreciated that the content may be associated with various applications on various device platforms, such as a web browser, an application hosted by a video game console, a mobile device app, a desktop application, a tablet application, etc. For example, while interacting with a video game price list through a shopping application on a mobile phone, the first user may invoke a populate button to send the topic populate request to a topic component (e.g., a local component, a cloud based component, etc.) for processing.

At 110, a first entry may be added into the topic collection based upon the content. In one example, a URL to a source of the content, an application shortcut to the first application that provided the content, a snapshot of the content, text, an image, XML data, and/or other content from the video game price list and/or the shopping application, for example, may be populated into the first entry. In another example, an image associated with the content (e.g., a video game logo image within the video game price list) may be populated into the first entry as an identification image for the content (e.g., the first user may have selected the video game logo image from a list of potential images extracted from the video game price list). The identification image may be displayed when a user accesses the video game topic collection, which may help the user remember the content with which the first entry is associated. In another example, a user comment (e.g., the first user may provide a brief description of the video game price list) describing the content may be received. The user comment may be populated into the first entry as a description of the content. In this way, the first entry may be populated in an organized manner for further accessibility, review, and/or sharing.

It may be appreciated that one or more entries may be added to the topic collection and/or that one or more topic collections may be maintained for the first user. In one example, a second topic populate request corresponding to second content may be received. For example, while reading a video game review through an application on a video game console (e.g., a second application different than the first application), the first user may invoke a populate button to send the second topic populate request to the topic component for processing. A second entry may be added into the topic collection based upon the second content. In one example, an image associated with the second content (e.g., a logo of the video game review company) may be populated into the second entry as an identification image for the second content (e.g., the first user may have selected the logo from a list of potential images extracted from the video game review). In another example, a user comment describing the second content may be populated into the second entry as a description of the second content. In this way, the second entry may be populated in an organized manner for further accessibility, review, and/or sharing.

Access to the topic collection may be provided to the first user. In one example, an interactive topic collection user interface may be provided to the first user through a web-based interface (e.g., a web page), a local application (e.g., a topic collection management application), a cloud-based application, a widget, a video game console application, a mobile device app, etc. The topic collection user interface may allow the user to explore one or more topic collections maintained for the first user and/or shared with the first user by other users. In one example, responsive to the first user invoking an entry selection operation of the first entry, the first user may be directed to a source of the content associated with the first entry (e.g., a link to the video game price list and/or the shopping application may be used to navigate the first user to the video game price list). In another example, the first user may be able to invoke an organize topic collection operation to remove an entry, add an entry, update an entry, and/or perform other functionality associated with a topic collection. In this way, the user may access and/or manage a topic collection from various devices.

The first user may share the topic collection with a second user. For example, a share request to share the topic collection with a second user may be received. Accordingly, the second user may be provided access to the topic collection. In one example, the topic collection may be shared through a social network. In another example, the topic collection may be shared through email. In another example, the topic collection may be shared through a collaborative experience that facilitates modification to the topic collection by the second user (e.g., the second user may add, remove, update, and/or comment on entries within the topic collection).

Recommendations of supplemental content (e.g., content not already associated with an entry within the topic collection) may be provided to the first user, which may help the first user identify additional content not already considered by the first user. In one example of providing a recommendation, supplement content for the topic collection may be identified based upon features of the topic collection (e.g., features of the first entry associated with the video game price list). In one example, a search engine may be used to identify relevant web-based content, such as websites, as supplemental content (e.g., a web search may be performed using features extracted from the first entry as search query terms). In another example, a second topic collection associated with a second user may be identified based upon the topic collection being assigned a first topic (e.g., video game purchase) that corresponds to a second topic (e.g., video game purchase) assigned to the second topic collection. An entry within the second topic collection that is not comprised within the topic collection may be identified (e.g., an entry corresponding to a video game walkthrough blog). Supplemental content may be derived from the entry within the second topic collection. In this way, a recommendation comprising the supplemental content may be provided, such as through the interactive topic collection user interface. At 112, the method ends.

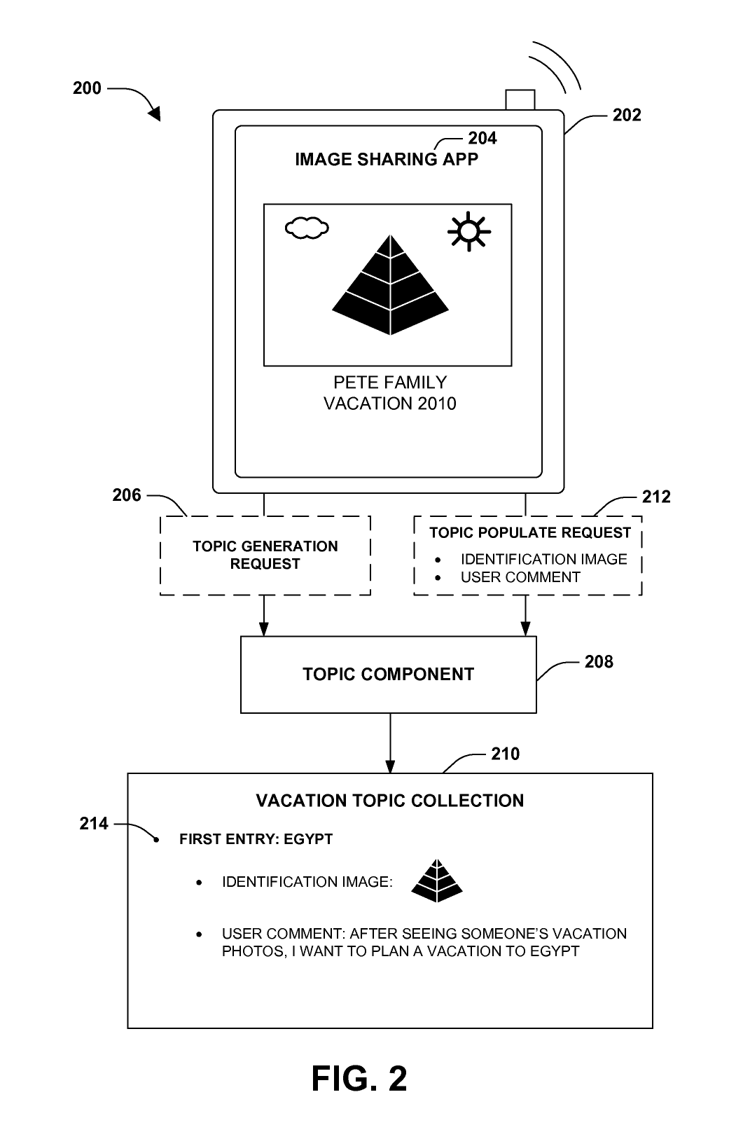

FIG. 2 illustrates an example of a system 200 configured for maintaining a topic collection. The system 200 may comprise a topic component 208. The topic component 208 may be configured to generate one or more topic collections for a user. For example, the topic component 208 may be configured to receive a topic generation request 206 (e.g., a first user may desire to create a vacation topic collection 210 within which content associated with planning an upcoming vacation may be stored and organized). Accordingly, the topic component 208 may be configured to generate a topic collection, such as the vacation topic collection 210, for the first user based upon the topic generation request 206.

The topic component 208 may be configured to populate the vacation topic collection 210. For example, the first user may browse an image sharing app 204 on a mobile device 202 to obtain vacation destination ideas. Upon identifying content that may be useful in planning the vacation, the first user may invoke a populate function through the mobile device 202. The topic component 208 may be configured to receive a topic populate request 212 corresponding to content (e.g., an image and description of a family vacation) associated with the image sharing app 204. The topic component 208 may be configured to add a first entry 214 into the vacation topic collection 210 based upon the content.

In one example, the topic component 208 may extract one or more images from the content associated with the image sharing app 204. The one or more images may be presented to the first user for selection of an identification image for the content associated with the first entry 214 (e.g., an image that may later remind the user of content associated with the first entry 214). For example, the user may select a pyramid image as the identification image. In this way, the topic component 208 may add the image into the first entry 214 as the identification image of the content. In another example, the topic component 208 may receive a user comment that describes the content. For example, the first user may write a brief summary of the content “after seeing someone's vacation photos, I want to plan a vacation to Egypt”. In this way, the topic component 208 may add the user comment into the first entry 214. It may be appreciated that the topic component 208 may add other information into the first entry 214 (e.g., and/or other entries), such as a link to the image sharing app 204, a link to the Pete family vacation 2010 content, etc. In this way, the topic component 208 may generate and/or populate the vacation topic collection 210.

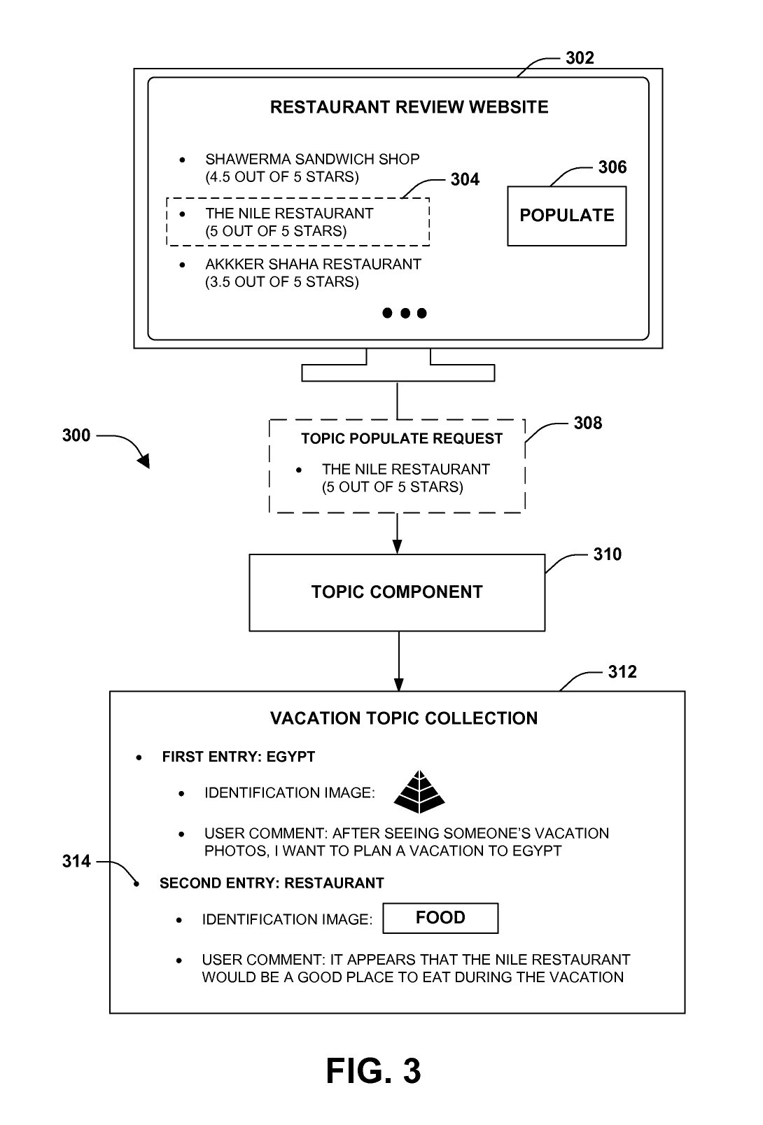

FIG. 3 illustrates an example of a system 300 configured for maintaining a topic collection. It may be appreciated that in one example, a vacation topic collection 312 may correspond to the vacation topic collection 210 that was generated in FIG. 2. The system 300 may comprise a topic component 310. The topic component 310 may be configured to populate the vacation topic collection 312 with one or more entries associated with content of applications. For example, the topic component 310 may have populated the vacation topic collection 312 with a first entry “Egypt” that corresponds to content associated with an image sharing app, as illustrated in FIG. 2. The topic component 310 may be configured to populate the vacation topic collection 312 with additional entries.

In one example of populating the vacation topic collection 312, the topic component 310 may be configured to receive a topic populate request 308. For example, the first user may search a restaurant review website 302 on a computing device to obtain reviews for restaurants in Egypt that may be interesting to eat at while on vacation. Upon identifying content that may be useful, such as a Nile Restaurant review 304, the first user may invoke a populate function 306 through a web browser displaying the restaurant review website 302. The topic component 310 may be configured to receive the topic populate request 308 corresponding to content (e.g., the Nile Restaurant review 304) associated with the restaurant review website 302 displayed by the web browser. The topic component 310 may be configured to add a second entry 314 into the vacation topic collection 312 based upon the topic populate request 308.

In one example, because the restaurant review website 302 may not comprise an image, the topic component 310 may allow the first user to upload an identification image and/or may provide the first user with one or more suggested images (e.g., an image “FOOD”) for selection as the identification image. For example, the user may select the suggested image “FOOD” as the identification image because the suggested image “FOOD” may remind the first user that the second entry 314 corresponds to the Nile Restaurant review 304 content. In this way, the topic component 310 may add the identification image to the second entry 314. In another example, the topic component 310 may receive a user comment that describes the content. For example, the first user may write a brief summary of the content “It appears that the Nile Restaurant would be a good place to eat during the vacation”. In this way, the topic component 310 may add the user comment into the second entry 314. It may be appreciated that the topic component 310 may add other information into the second entry 314, such as a hyperlink to the restaurant review website 302. In this way, the topic component 310 may populate the vacation topic collection 312 with one or more entries.

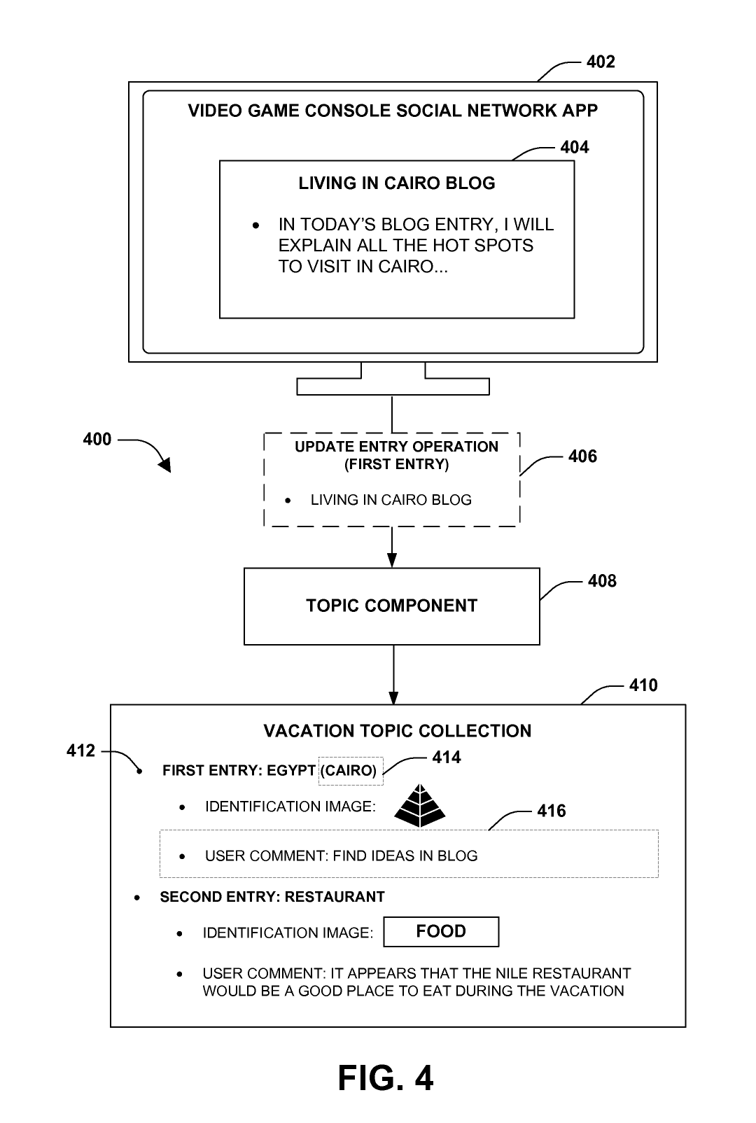

FIG. 4 illustrates an example of a system 400 configured for maintaining a topic collection. It may be appreciated that in one example, a vacation topic collection 410 may correspond to the vacation topic collection 210 in FIG. 2 and/the vacation topic collection 312 of FIG. 3. The system 400 may comprise a topic component 408. The topic component 408 may be configured to maintain one or more topic collections, such as the vacation topic collection 410, on behalf of a first user. For example, the topic component 408 may have populated the vacation topic collection 410 with a first entry 412 “Egypt” that corresponds to content associated with an image sharing app, as illustrated in FIG. 2. The topic component 408 may have populated the vacation topic collection with a second entry “Restaurant” that corresponds to content associated with a restaurant review web page, as illustrated in FIG. 3.

The topic component 410 may be configured to perform one or more organize topic collection operations upon the vacation topic collection 410, such as a remove entry operation, an add entry operation, and/or an update entry operation, for example. In one example, the topic component 410 may be configured to receive an update entry operation 406 for the first entry from a first user. For example, the first user may read a Living in Cairo Blog 404 through a video game console social network app 402 hosted by a video game console to obtain information about interesting places to visit while vacationing in Egypt. Accordingly, the first user may submit the update entry operation 406 to the topic component 408 to update the first entry 412 based upon the content of the Living in Cairo Blog 404. In one example, a topic assigned to the first entry 412 may be modified from Egypt to Egypt (Cairo) 414 because the user may now be interested in visiting Cairo during the vacation based upon the content of the Living in Cairo Blog 404. In another example, a user comment may be modified to state “find ideas in blog” 416, which may help the first user remember that the Living in Cairo Blog 404 is now associated with the first entry (e.g., as opposed to the image sharing app). It may be appreciated that other information may be added, removed, and/or changed for the first entry 412. For example, a link to the image sharing app may be removed, and a new link to the Living in Cairo Blog 404 may be added to the first entry 412. In this way, the topic component 408 may perform various organize topic collection operations upon one or more entries within the vacation topic collection 410.

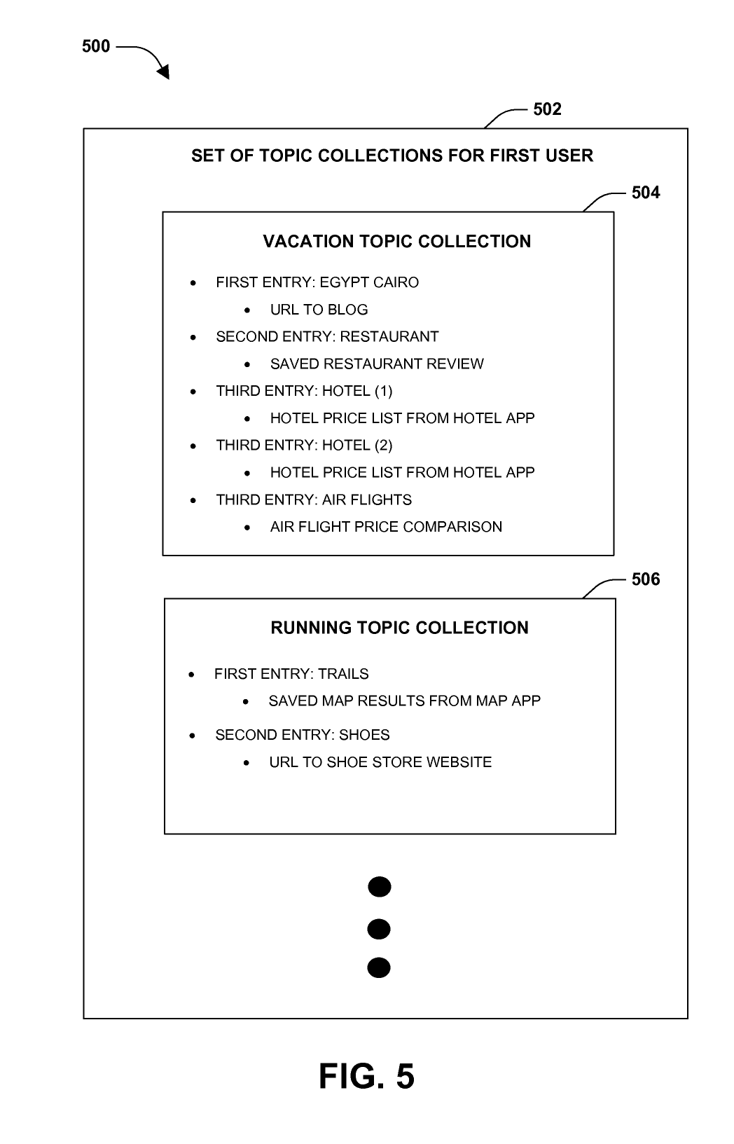

FIG. 5 illustrates an example 500 of a set of topic collections 502 for a first user. A vacation topic collection 504, a running topic collection 506, and/or other topic collections not illustrated may be maintained for the first user within the set of topic collections 502. In one example, the first user may have an interest in planning a vacation. As the first user discovers content through various applications and/or computing devices over time, one or more entries may be added to the vacation topic collection 504. For example, the user may add a first entry (e.g., a URL to a vacation blog) corresponding to content of a vacation blog provided by a video game console social network app. The first user may add a second entry (e.g., a saved portion of a restaurant review) corresponding to content of a restaurant review provided by a restaurant app on a tablet device. In this way, the vacation topic collection 504 may be populated with one or more entries that the first user may review, organize, and/or share.

In another example, the first user may have an interest in running a marathon. As the first user discovers content through various applications and/or computing devices over time, one or more entries may be added to the running topic collection. For example, the user may add a first entry corresponding to content of a map (e.g., a saved portion of the map) provided by a map app on a mobile device. In this way, the running topic collection 506 may be populated with one or more entries that the first user may review, organize, and/or share.

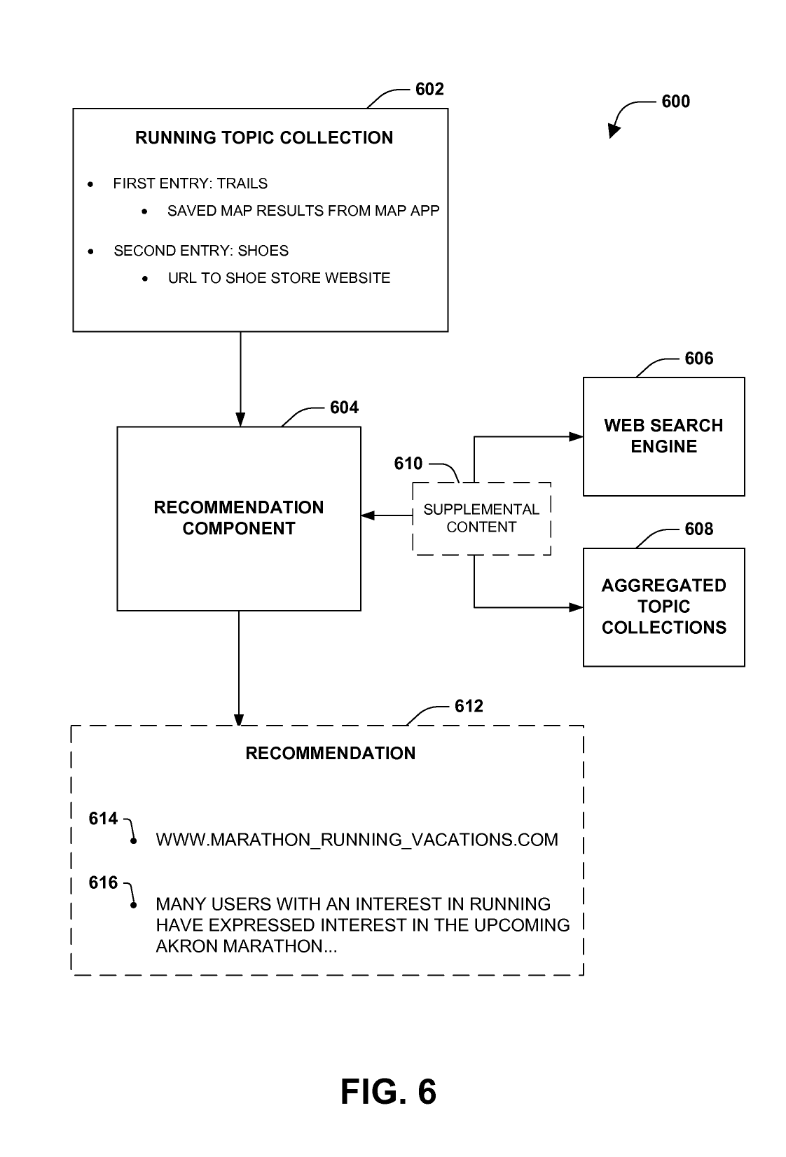

FIG. 6 illustrates an example of a system 600 configured for providing a recommendation 612 for a topic collection associated with a first user. The first user may have an interest in running a marathon. As such, a topic component may create a running topic collection 602 within which the first user may add content as one or more entries. The topic component may add a first entry corresponding to content of a map that the first user viewed through a map app. The topic component may add a second entry corresponding to content of a shoe store website that the first user viewed through a web browser. Because a plethora of information may be available for running marathon through various websites and applications, it may be impractical for the first user to discover additional information that may be useful to the first user. Accordingly, the system 600 may comprise a recommendation component 604 configured to provide the recommendation 612 of supplemental content 610 to the first user.

In one example of identifying supplemental content 610 for the recommendation 612, the recommendation component 604 may identify features of the running topic collection 602 (e.g., key words, topics, URLs, and/or other information that may be used to locate information that may be relevant to running a marathon) and/or features of other topic collections associated with the first user. The recommendation component 604 may use the features to perform a search query (e.g., the features may be used as search terms) through a web search engine 606 to locate supplemental content that may be relevant to the running topic collection 602. For example, first supplemental content 614 may be identified based upon the web search engine 606 returning a search result comprising a marathon running vacation website. In this way, the recommendation component 604 may add the first supplemental content 614 into the recommendation 612.

In another example of identifying supplemental content 610 for the recommendation 612, the recommendation component 604 may use the features of the running topic collection 602 to identify entries within aggregated topic collections 608 (e.g., topic collections of one or more users) with similar features. For example, the recommendation component 604 may identify one or more entries within one or more topic collections (e.g., running topic collections maintained for other users) that correspond to content of an upcoming marathon. Second supplemental content 616 may be identified based upon the one or more entries, and may be added to the recommendation 612. The recommendation 612 may be provided to the first user as a suggestion of additional content that may be relevant and/or helpful for accomplishing a search task (e.g., gaining knowledge about running) associated with the running topic collection 602.

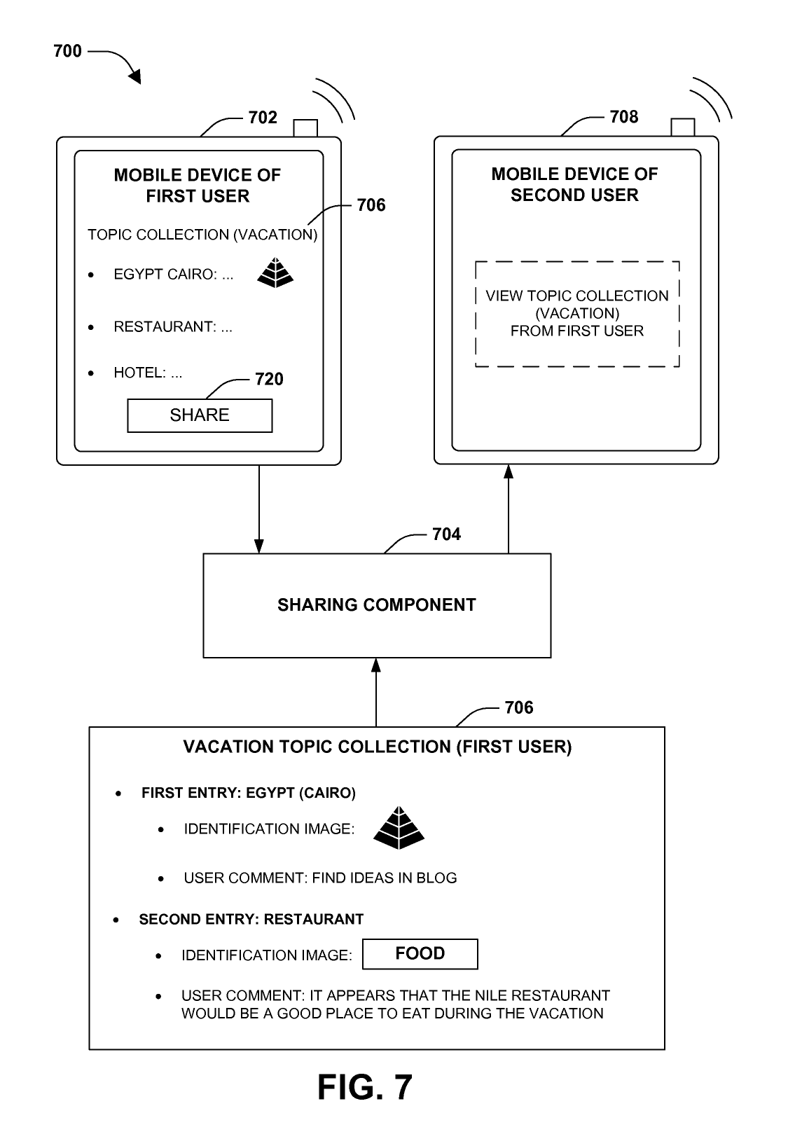

FIG. 7 illustrates an example of a system 700 configured for sharing a topic collection from a first user to one or more other users. The first user may be associated with a vacation topic collection 706 comprising one or more entries added to the vacation topic collection 706 based upon content that the first user found interesting. The system 700 may comprise a sharing component 704. The sharing component 704 may be configured to receive a share request from the first user (e.g., through a topic collection user interface that provides the first user with access to the vacation topic collection 706 on a mobile device 702). A share button 720, for example, may facilitate execution of the share request. The share request may indicate that the first user wants the second user to have a particular level of access (e.g., read only access that allows the second user to merely view the vacation topic collection; full access that allows the second user to add an entry, deleted an entry, update an entry, and/or perform other organization operations; and/or other varying levels of access) to the vacation topic collection 706. In this way, the sharing component 704 may provide the second user on mobile device 708 with access to vacation topic collection 706.

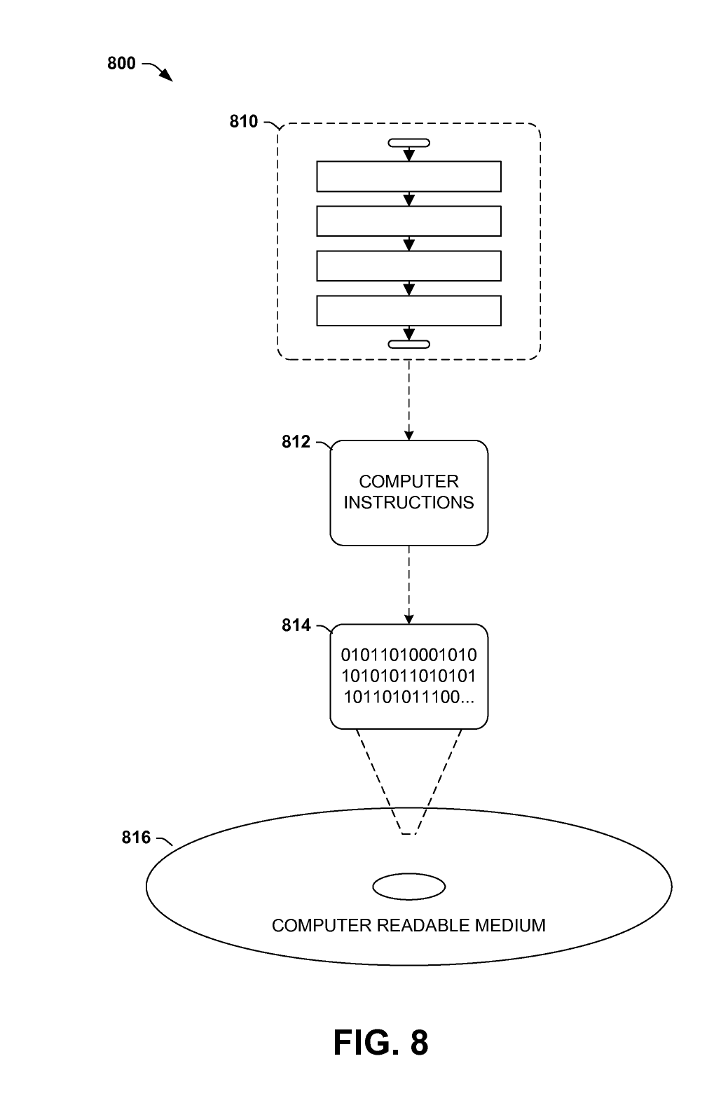

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as at least some of the exemplary method 100 of FIG. 1, for example. In another such embodiment, the processor-executable instructions 812 may be configured to implement a system, such as, at least some of the exemplary system 200 of FIG. 2, at least some of the exemplary system 300 of FIG. 3, at least some of exemplary system 400 of FIG. 4, at least some of the exemplary system 600 of FIG. 6, and/or at least some of the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

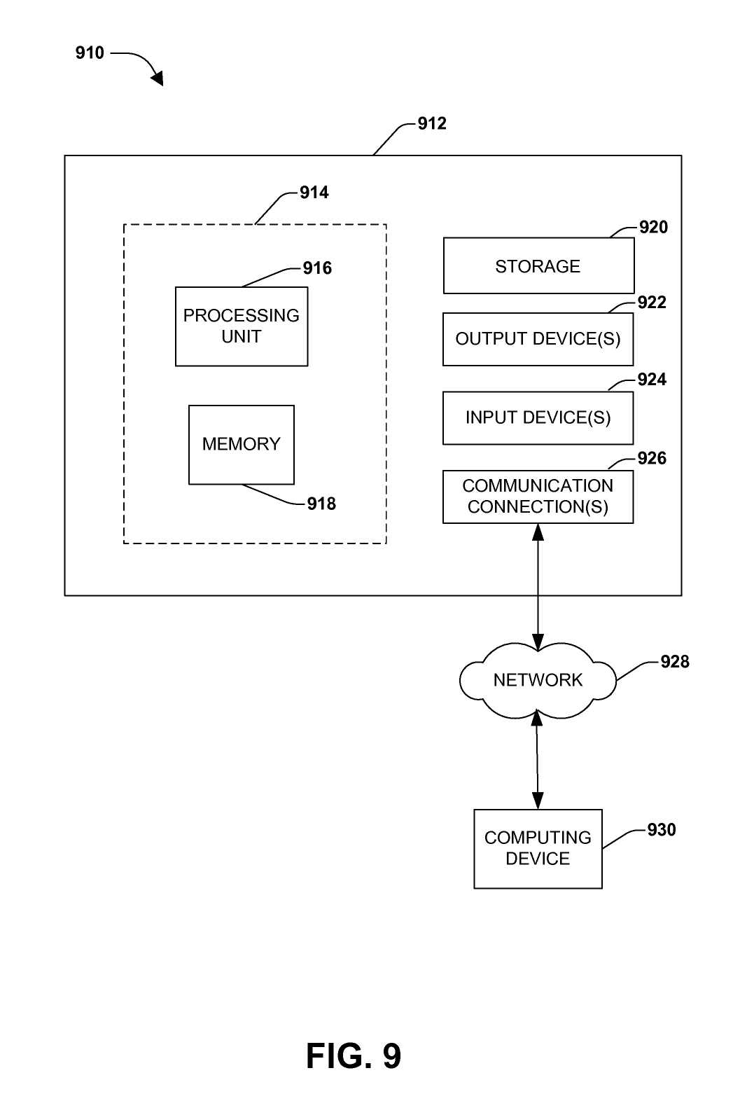

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for maintaining a topic collection, comprising:
receiving a topic generation request;
generating a topic collection based upon the topic generation request;
receiving a topic populate request corresponding to content associated with a first application; and
adding a first entry into the topic collection based upon the content.

2. The method of claim 1, the adding a first entry into the topic collection comprising:
responsive to a selection of an image associated with the content, adding the image into the first entry as an identification image for the content.

3. The method of claim 1, the adding a first entry into the topic collection comprising:
responsive to receiving a user comment describing the content, adding the user comment into the first entry as a description of the content.

4. The method of claim 1, the first application comprising at least one of:
a web browser;
an application hosted by a video game console;
a tablet application,
a mobile device app; or
a desktop application.

5. The method of claim 1, comprising:
receiving a second topic populate request corresponding to second content; and
adding a second entry into the topic collection based upon the second content.

6. The method of claim 5, the adding a second entry into the topic collection comprising least one of:
responsive to a selection of an image associated with the second content, adding the image into the second entry as an identification image for the second content; or
responsive to receiving a user comment describing the second content, adding the user comment into the second entry as a description of the second content.

7. The method of claim 5, the second content associated with a second application different than the first application.

8. The method of claim 1, comprising:
providing access to the topic collection to a first user associated with the topic collection.

9. The method of claim 8, the providing access to the topic collection comprising at least one of:
navigating to a source of the content based upon an entry selection operation of the first entry;
displaying content of the first entry; or
performing an organize topic collection operation comprising at least one of: remove entry operation, an add entry operation, or an update entry operation.

10. The method of claim 8, comprising:
receiving a share request from the first user to share the topic collection with a second user; and
providing the second user with access to the topic collection.

11. The method of claim 10, the providing the second user with access to the topic collection comprising at least one of:
sharing the topic collection through a social network;
sharing the topic collection through email; or
sharing the topic collection through a collaborative experience that facilitates modification of the topic collection by the second user.

12. The method of claim 1, comprising:
identifying supplemental content for the topic collection based upon the first entry, the supplemental content not comprised within the topic collection; and
providing a recommendation comprising the supplemental content.

13. The method of claim 12, the identifying supplemental content comprising:
performing a web search based upon data stored within the first entry.

14. The method of claim 12, the topic collection associated with a first user, the identifying supplemental content comprising:
identifying a second topic collection associated with a second user based upon the topic collection being assigned a first topic that corresponds to a second topic assigned to the second topic collection;
identifying an entry within the second topic collection that is not comprised within the topic collection; and
deriving supplemental content from the entry within the second topic collection.

15. The method of claim 8, comprising:
maintaining a second topic collection for the first user, the topic collection being assigned a first topic that is different than a second topic assigned to the second topic collection.

16. A system for maintaining a topic collection comprising:
a topic component configured to:
receive a topic generation request;
generate a topic collection based upon the topic generation request;
receive a topic populate request corresponding to content associated with a first application; and
add a first entry into the topic collection based upon the content, comprising at least one of:
responsive to a selection of an image associated with the content, add the image into the first entry as an identification image for the content; or
responsive to receiving a user comment describing the content, add the user comment into the first entry as a description of the content.

17. The system of claim 16, the topic component configured to:
receive a second topic populate request corresponding to second content; and
add a second entry into the topic collection based upon the second content.

18. The system of claim 16, comprising:
a recommendation component configured to:
identify supplemental content for the topic collection based upon the first entry, the supplemental content not comprised within the topic collection; and
provide a recommendation comprising the supplemental content.

19. The system of claim 16, comprising:
a sharing component configured to:
receive a share request from a first user, associated with the topic collection, to share the topic collection with a second user; and
provide the second user with access to the topic collection.

20. A computer-readable medium comprising processor-executable instructions that when executed perform a method for maintaining a topic collection, comprising:
receiving a topic generation request;
generating a topic collection based upon the topic generation request;
receiving a topic populate request corresponding to content associated with a first application; and
adding a first entry into the topic collection based upon the content, the adding the first entry comprising at least one of:
responsive to a selection of an image associated with the content, adding the image into the first entry as an identification image for the content; or
responsive to receiving a user comment describing the content, adding the user comment into the first entry as a description of the content.
